(19) United States
(12) Patent Application Publication
(10) Pub. No.: US 2006/0128227 A1
(43) Pub. Date: Jun. 15, 2006

(54) Modular socket with a preventer

(76) Inventor: Huang-Chou Huang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/010,400

(22) Filed: Dec. 14, 2004

(51) Int. Cl. H01R 24/00

(52) U.S. Cl. 439/676

(57) ABSTRACT

A modular socket with a preventer has a jack cavity, multiple pins and a preventer. The jack cavity has an open front, a top, an inner bottom, two sidewalls and a rear wall. The pins are mounted in parallel in the jack cavity on the inner bottom. The preventer is mounted in the jack cavity, is H-shaped and has a bar stop, two mounting arms and two resilient inclined tabs. The mounting arms extend back from the ends of the bar stop outside the pins and attach to the rear wall of the jack cavity. The resilient inclined tabs extend forward and down from ends of the bar stop and press against the bottom of the jack cavity. When a correctly sized modular jack is inserted into the socket, the modular jack presses the resilient inclined tabs and the bar stop down and slides into the jack cavity.

### BACKGROUND OF THE INVENTION

1. Field of the Invention

The present invention relates to a modular socket and particularly to a modular socket with a preventer that keeps an undersized modular jack from being inserted into the socket.

2. Description of Related Art

Communication devices such as telephones, facsimile machines, modems and the like are used throughout the world. Most conventional communications devices use modular connectors to connect to the requisite communication medium to receive and transmit data.

However, different communication devices use different size modular connectors. Each modular connector has a modular jack with multiple pins and a corresponding modular socket with multiple wires. In a matched set of jack and socket, the wires in the jack correspond to and make contact with the pins in the socket. However, standard conventional modular connectors have different sizes, and the jack from a smaller sized connector can be plugged into a larger sized socket. For example, an RJ-11 modular connector for a telephone has a jack the same size as the socket in an RJ-12 modular connector for a telephone, and the RJ-11 jack can be plugged inadvertently into the RJ-12 socket. The RJ-11 and RJ-12 modular connectors have jacks smaller than the socket in the RJ-45 modular connector for a network. Consequently, either the RJ-11 or the RJ-12 jack could be inadvertently plugged into the RJ-45 socket. At best, the wires and pins would not align, and no data would be transferred. In a worst case, the communication device could be severely damaged.

With reference to FIG. 8, a multifunction modular socket assembly comprises a casing (30), a network socket (31) and a telephone socket (32). The sockets (31, 32) are mounted in the casing (30) and allow a communication device to be connected to an external telephone line and to a network with an RJ 45 jack (20) and the appropriate modular telephone jack.

The network socket (31) and the telephone socket (32) individually have an open front (312, 322), a jack cavity and multiple pins (311, 321). The open front (312) of the network socket (31) is wider than the open front (322) of the telephone socket (32). The jack cavity has an open front. The pins (311, 321) are installed respectively in the jack cavity of the network socket (31) and the telephone socket (32).

With further reference to FIGS. 9 and 10, the telephone socket (32) and the network socket (31) can be fabricated in opposite positions in the casing (30) in another embodiment of the multifunction modular socket assembly. The RJ 45 jack (20) is able to plug into the network socket (31). The RJ 45 jack (20) is wider than the open front (322) so that the RJ 45 jack (20) is not able to plug into the telephone socket (32). The open front (311) of the network socket (31) is wider than a RJ 12 jack (21) so that the RJ 12 jack (21) is able to plug into the network socket (31). It may cause that the wires and pins would not align, no data would be transferred or the communication device could be severely damaged.

To overcome the shortcomings, the present invention provides a modular socket with a preventer to obviate or mitigate the aforementioned problems.

### SUMMARY OF THE INVENTION

The primary objective of the present invention is to provide a modular socket with a preventer that keeps an undersized modular jack from being inserted into a larger modular socket.

The modular socket with a preventer comprises a jack cavity, multiple pins and a preventer.

The jack cavity has an open front, a top, an inner bottom, two sidewalls and a rear wall.

The pins are mounted in parallel in the jack cavity on the inner bottom.

The preventer is mounted in the bottom of a jack cavity, is H-shaped and has a bar stop, two mounting arms and two resilient inclined tabs. The bar stop has two ends. The mounting arms extend back from the ends of the bar stop outside the pins and attach to the rear wall of the jack cavity. The resilient inclined tabs extend forward and down from ends of the bar stop and press against the bottom of the jack cavity to hold the bar stop up in front of the pins.

When a correctly sized modular jack is inserted into the socket, the modular jack presses the resilient inclined tabs and the bar stop down and slides into the jack cavity. However, an undersized modular jack will not touch the resilient inclined tabs and will be stopped by the bar stop.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a socket assembly having a modular socket with a preventer in accordance with the present invention;

FIG. 2 is a partially exploded perspective view of the socket assembly in FIG. 1;

FIG. 3 is an operational perspective view of the socket assembly in FIG. 1 with a modular network jack being inserted;

FIG. 4 is an operational side view in partial section of the socket assembly in FIG. 3 with the modular network jack being inserted;

FIG. 5 is an operational side view in partial section of the socket assembly in FIG. 3 with the modular network jack fully inserted;

FIG. 6 is a top view in partial section of the socket assembly in FIG. 2 with an undersized modular jack being inserted;

FIG. 7 is a front view of another embodiment of a socket assembly having a modular socket with a preventer in accordance with the present invention with an undersized modular jack being inserted;

FIG. 8 is a partially exploded perspective view of a conventional socket assembly in accordance with the prior art;

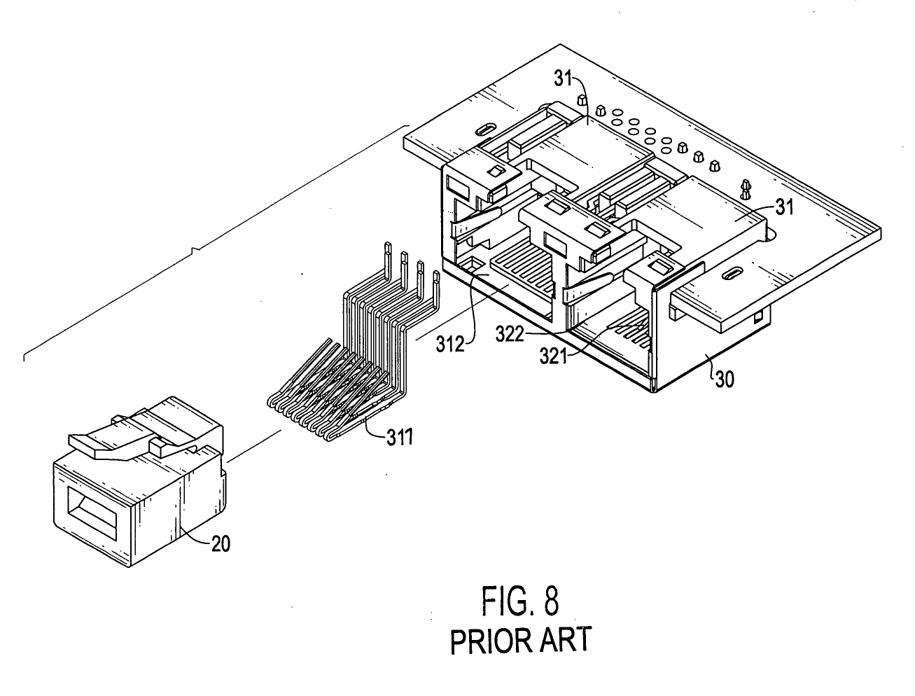

FIG. 9 is an operational front view of another embodiment of a conventional socket assembly with a modular network jack being inserted; and

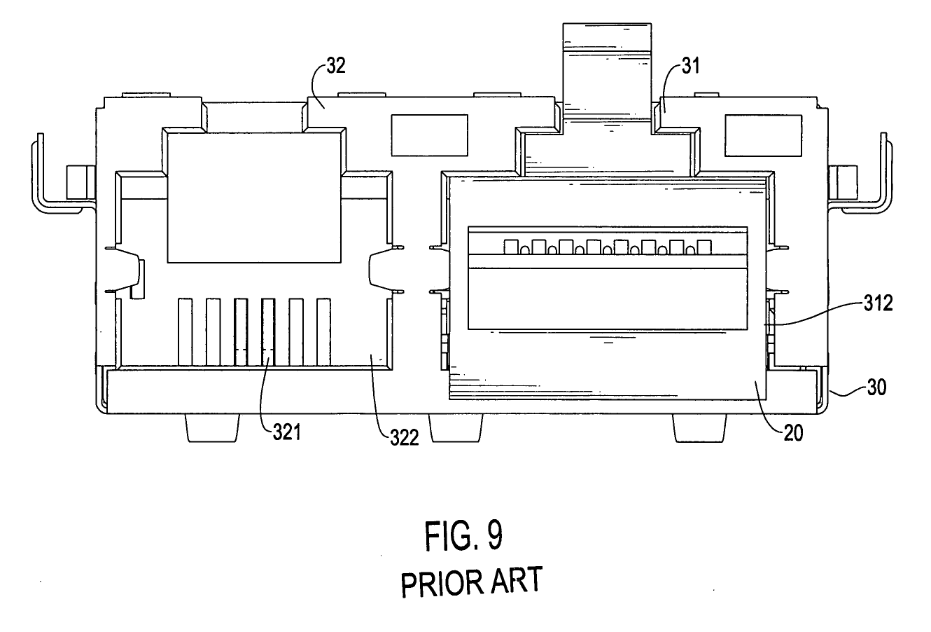

FIG. 10 is an operational front view of the socket assembly in FIG. 9 with an undersized modular jack being inserted.

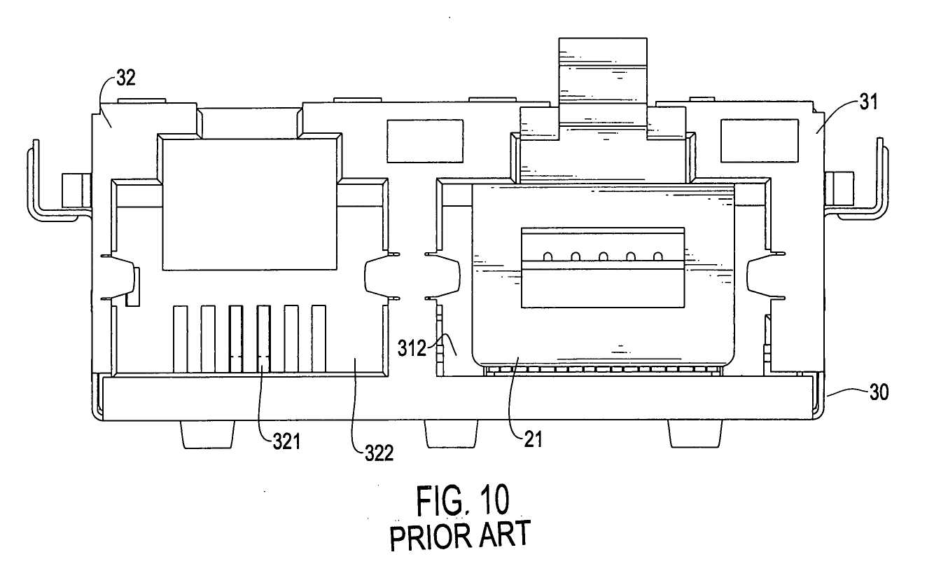

### DETAILED DESCRIPTION OF THE PREFERRED EMBODIMENT

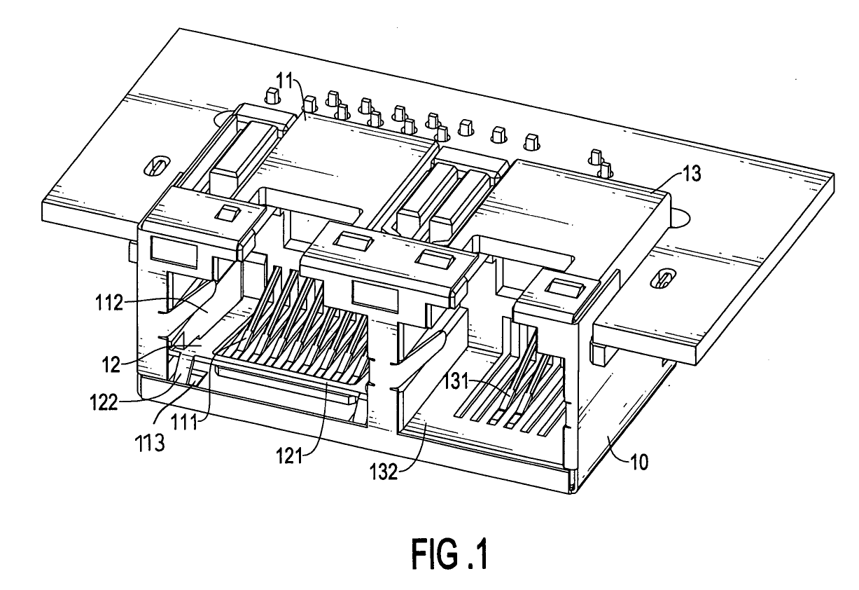

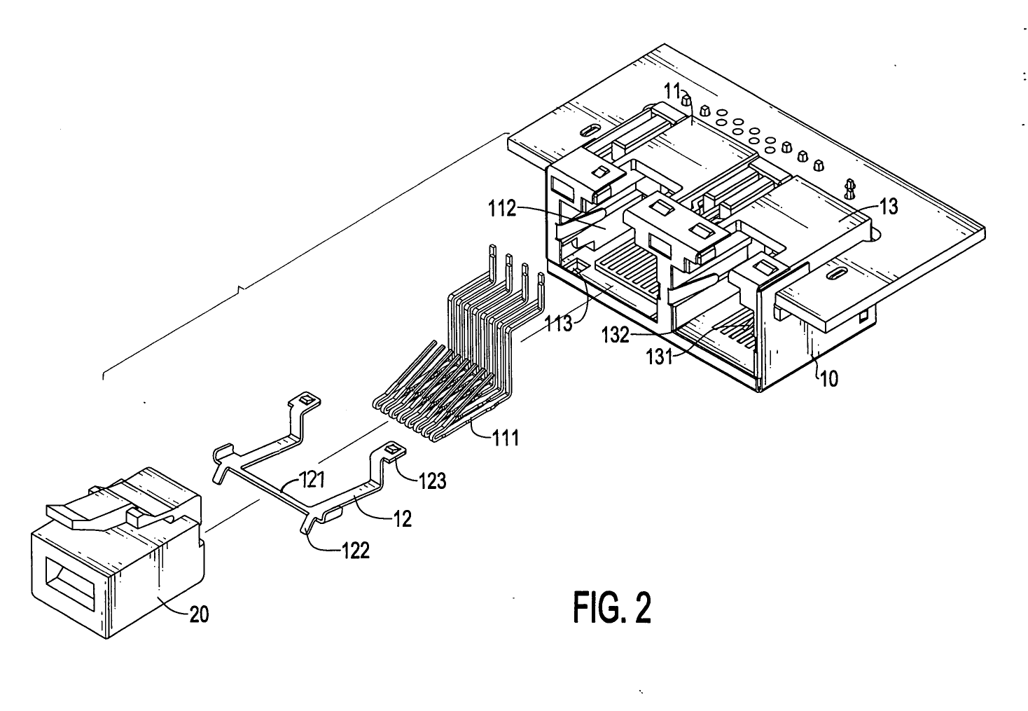

With reference to FIGS. 1 and 2, a modular socket with a preventer in accordance with the present invention comprises a jack cavity, multiple pins (111) and a preventer (12). The modular socket with a preventer may be configured as a single fitting, an assembly with multiple sockets one or more network sockets (11) and additional telephone sockets (13), an in line coupler or any other device with a modular connector.

Embodiments of the socket assembly described have a casing (10), a network socket (11) and a telephone socket (13) installed in the casing (10).

The network socket (11) has a jack cavity, multiple pins (111) and a preventer (12).

The jack cavity has an open front (112), an inner bottom, two sidewalls, a rear wall, multiple pin recesses and two tab recesses (113). The inner bottom has a front edge adjacent to the open front (112). The pin recesses are formed longitudinally in the inner bottom in parallel. The tab recesses (113) are formed in the bottom at the front edge adjacent respectively to the sidewalls.

The pins (111) are mounted respectively in the pin recesses.

The preventer (12) is mounted in the inner bottom of jack cavity of the network socket (11), is H-shaped and has a bar stop (121), two mounting arms (123) and two resilient inclined tabs (122). The bar stop (121) has two ends. The mounting arms (123) are formed on and extend back from the ends of the bar stop (121) outside the pins (111) and attach to the rear wall of the jack cavity. The resilient inclined tabs (122) are formed on and extend forward and down from the ends of the bar stop (121) into the tab recesses (113).

The telephone socket (13) may be conventional, has an open front (132), an inner space, an inner bottom, multiple pin recesses and multiple pins (131) and is not further described.

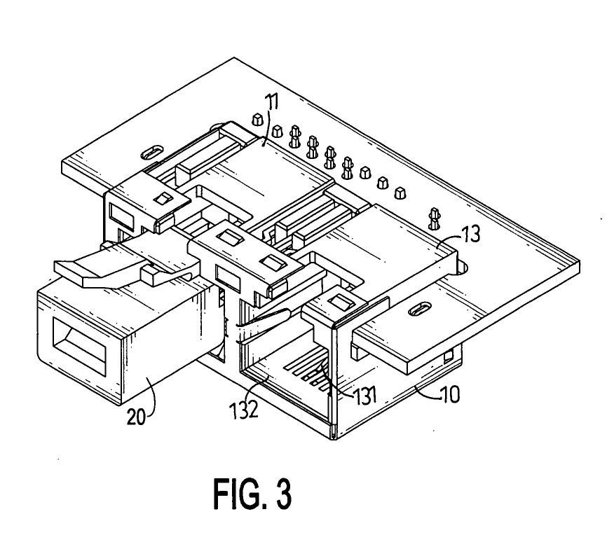

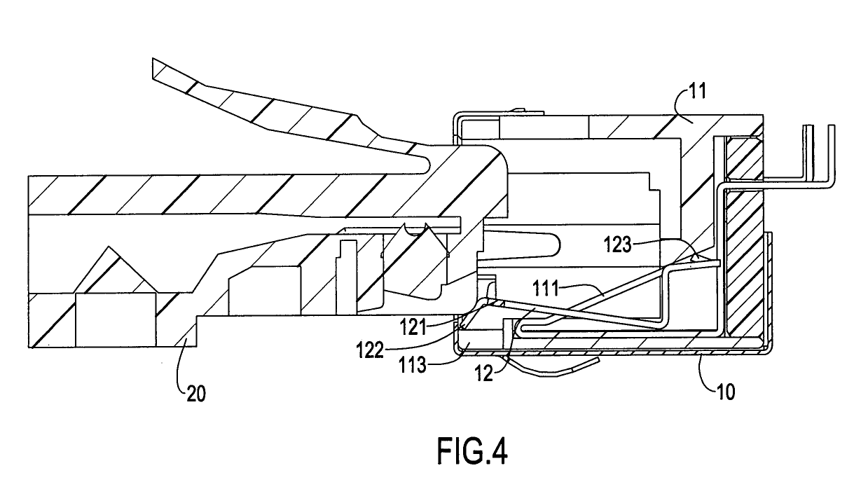

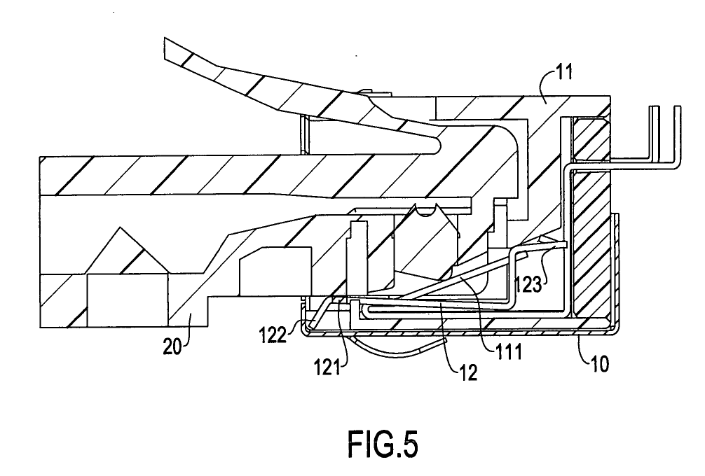

With reference to FIGS. 3, 4 and 5, an RJ 45 jack (20) is plugged into the network socket (11) through the open front (112) of the jack cavity. The RJ 45 plug (20) contacts the resilient inclined tabs (122) and forces the resilient inclined tabs (122) into the tab recesses (113). The bar stop (121) of the preventer (12) moves toward the inner bottom of the jack cavity so the RJ 45 jack (20) can be pushed completely into the jack cavity. The RJ 45 plug (20) contacts the pins (111) so data can pass through the modular connector.

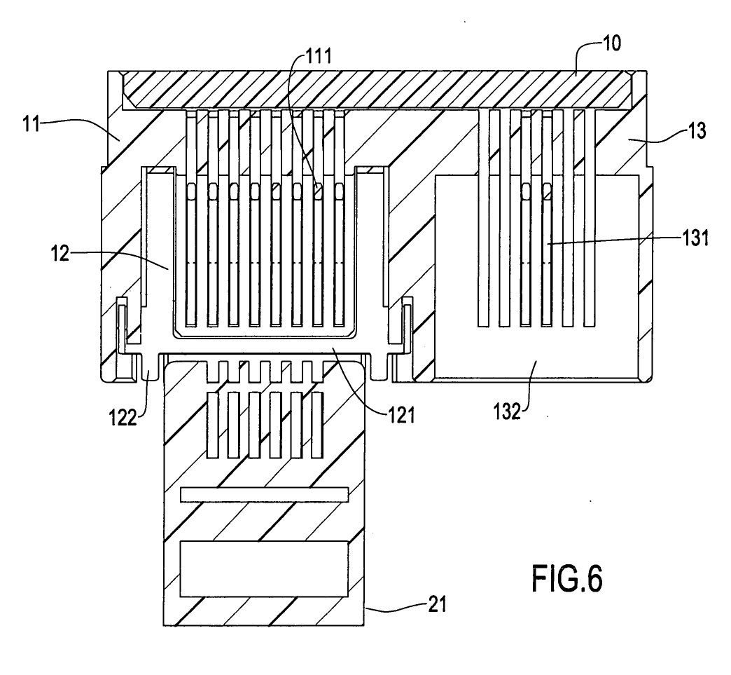

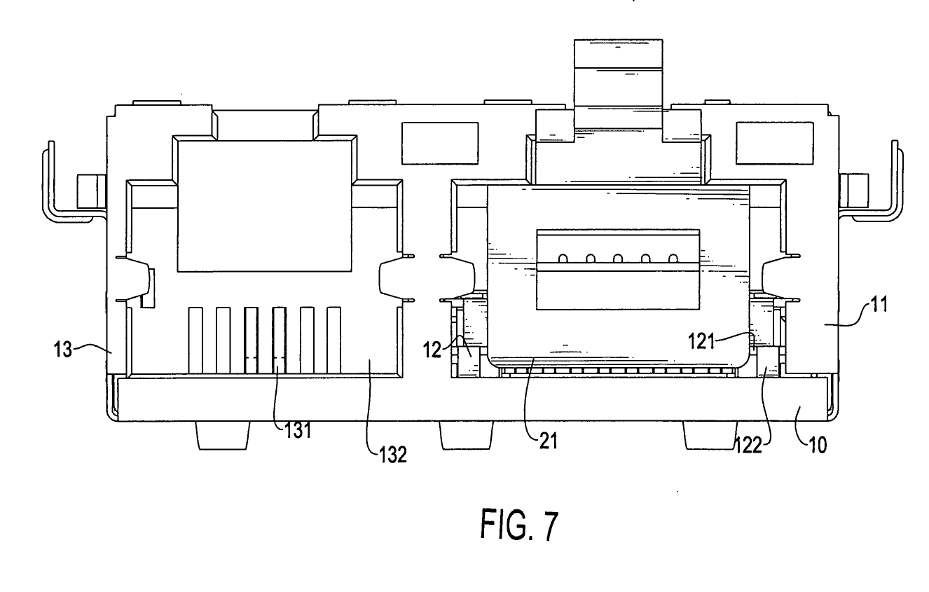

With further reference to FIGS. 6 and 7, attempting to plug an RJ-12 jack (21) into the network socket (11) will be prevented by the preventer (12). Since an RJ-12 plug (21) is narrower than the open front (112) of the jack cavity of the network socket (11), the RJ-12 plug (21) press the inclined tabs (122) of the preventer (12). The bar stop (121) of the preventer (12) stops the RJ-12 plug (21) from being inserted into the jack cavity of the network socket (11). The network socket (11) can reject the undersize RJ 12 plug (21) insetting into. It is noticed that the preventer (12) can avoid the undersize RJ 12 plug (21) being plugged into the network socket (11) to keep the wires and pins would align, data would be transferred or the communication device could be usability.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A socket with a preventer comprises
a jack cavity having
an open front;
an inner bottom having a front edge adjacent to the open front;
two sidewalls;
a rear wall;
multiple pin recesses formed longitudinally in the inner bottom in parallel; and
two tab recesses formed in the bottom at the front edge adjacent respectively to the sidewalls;
multiple pins mounted respectively in the pin recesses; and
a preventer mounted in the inner bottom of the jack cavity of the network socket, being H-shaped and having
a bar stop having two ends;
two mounting arms formed on and extending from the ends of the bar stop outside the pins and attached to the rear wall of the jack cavity; and
two resilient inclined tabs formed on and extending down from the ends of the bar stop into the tab recesses.
